(19) United States
(12) Patent Application Publication
(10) Pub. No.: US 2020/0279249 A1
(43) Pub. Date: Sep. 3, 2020

(54) BLOCKCHAIN-BASED DIGITAL ASSET PLATFORM

(71) Applicant: CoinLinked, Inc., Fountain Valley, CA (US)

(72) Inventor: Jenny Q. Ta, Fountain Valley, CA (US)

(21) Appl. No.: 16/804,479

(22) Filed: Feb. 28, 2020

Related U.S. Application Data
(60) Provisional application No. 62/812,130, filed on Feb. 28, 2019.

(51) Int. Cl. G06Q 20/38; G06Q 20/06; G06Q 20/36; G06Q 20/40; G06Q 50/00; G06Q 30/06; G06Q 30/02; G06Q 40/04; G06F 16/27; G06F 9/54; G06F 16/23; H04L 9/06

(52) U.S. Cl. CPC G06Q 20/381; G06Q 20/0655; G06Q 20/3678; G06Q 20/401; G06Q 50/01; G06Q 30/0631; H04L 9/0643; G06Q 30/0613; G06Q 20/3672; G06Q 40/04; G06F 16/27; G06F 9/54; G06F 16/2379; G06Q 30/0214

(57) ABSTRACT

A method of executing a transaction on a social commerce network associated with a cryptocurrency transaction system includes receiving, from a client device, a purchase request to purchase a good or service from a third-party retailer. The method further includes converting a cost of the good or service from a fiat currency provided by the third-party retailer to a cryptocurrency cost. The method further includes providing, to the client device, a transaction request comprising the cryptocurrency cost and an address associated with a cryptocurrency wallet blockchain of the cryptocurrency transaction system. The method further includes, in response to verifying a transaction comprising cryptocurrency assets associated with the transaction request, executing the purchase request in fiat currency on the third-party retailer by a processing device.

### CROSS-REFERENCE TO RELATED APPLICATIONS

This application claims the benefit of U.S. Provisional Patent Application No. 62/812,130, filed on Feb. 28, 2019, the entire contents of which are incorporated by reference herein.

### FIELD

The present invention relates to blockchain systems, and more particularly, relates to blockchain-based digital asset platforms.

### BACKGROUND

Blockchain refers to a decentralized leger containing linked blocks of information. Each block contains a cryptographic hash of the previous block, a timestamp, and data (e.g., transaction data). Once recorded, data in any given block of a blockchain may not be edited without also editing all subsequent blocks in the blockchain. Managed by a peer-to-peer network, blockchain allows for efficient and permanent recordkeeping.

Blockchain technology is growing increasingly popular in all areas of computer processing, and especially with respect to digital payment systems. Blockchain-based cryptocurrencies (e.g., BitCoin, Ethereum, etc.) provide for a secure method of peer-to-peer transfer of digital assets (e.g., digital currency). While blockchain-based currencies are becoming increasingly popular, there still exists a large number of online marketplaces that do not yet accept such digital currencies.

### BRIEF DESCRIPTION OF THE DRAWINGS

FIG. 1 illustrates a flow diagram of a buy order method of a blockchain-based exchange platform, according to one embodiment.

FIG. 2A illustrates a first flow diagram of a refund method of a blockchain-based exchange platform, according to one embodiment.

FIG. 2B illustrates a second flow diagram of a refund method of a blockchain-based exchange platform, according to one embodiment.

FIG. 3 illustrates a flow diagram of a data custody method of a blockchain-based exchange platform, according to one embodiment.

FIG. 4 illustrates an example token economy system and method of a blockchain-based exchange platform, according to one embodiment.

FIG. 5A illustrates a first system and flow diagram of a token lifecycle, according to one embodiment.

FIG. 5B illustrates a second system and flow diagram of a token and credit lifecycle, according to one embodiment.

FIG. 6 illustrates a flow diagram of a blockchain-based exchange, according to one embodiment.

FIG. 7 is a block diagram of an example apparatus that may perform one or more of the operations described herein, in accordance with one embodiment.

### DETAILED DESCRIPTION

A blockchain-based exchange platform is described herein. In particular, in one embodiment, a platform that facilitates fiat-currency transactions with third-party retailers (e.g., retailers outside of the platform described herein) using blockchain-based digital currency (e.g., cryptocurrency) is described. A variety of problems may exist with current online marketplaces and transaction platforms. For example, it may be difficult for users to spend digital assets in everyday e-commerce as few merchants accept digital asset payments. This may present a problem for users who would like to use digital currency, instead of fiat currency, to purchase from existing marketplaces. Existing solutions may require merchants to change point-of-sale software or integrate new payment software to handle cryptocurrency transactions. In some embodiments, transaction platforms may offer crypto-based “cashback” rewards, but do not allow users to pay in cryptocurrencies.

A variety of barriers to entry exist for existing cryptocurrency platforms, such as painful and confusing onboarding process can be for new users. With a vast array of exchanges, wallets, and laws to navigate, it can be extremely difficult for a merchant to know which currencies are worth accepting, and how to accept them. Furthermore, in situations where cryptocurrencies are accepted as a form of payment, confirmation times of up to ten minutes leave large windows of anxiety and uncertainty for new vendors.

Existing systems may also be lacking in support. Despite the fact that cryptocurrencies currently boast a multi-billion-dollar market, there are very few places that actually support them as a medium-of-exchange. Whether this is due to price volatility or the barriers to entry mentioned above, it should come as no surprise that many traditional businesses have yet to accept digital assets as a payment method for their business. In simple terms, most businesses today would rather receive fiat than obscure digital assets when attempting to navigate regulatory hurdles that naturally come with their integration. For those businesses that do accept cryptocurrencies, they're often limited to one or two assets at most, leaving many of the industry's rising projects to suffer from significant lags before vendors catch up with general market sentiment.

Additionally, existing platforms may be inefficient for a variety of reasons. While there are numerous blockchain companies aiming to tackle similar problems, most projects have ultimately created silos in which their native currency ends up becoming a bigger problem than what traditional systems have to offer. Furthermore, with price volatility causing the value of rewards earned by early adopters to fluctuate on a daily basis, it may be difficult to instill confidence that competing solutions will be relevant in the long-term.

For those solutions that support the payment of top currencies, issues surrounding custody often come into play. For example, many debit card solutions allow you to preload or stake to unlock spending, often requiring a significant degree of trust and large upfront commitments for these solutions to be of value in the short term.

Advantageously, the systems, platforms, and methods described herein overcome the above challenges and others. In one embodiment, CoinLinked (used for convenience to describe the system, platform, and methods described herein) is a social commerce network for purchasing any online goods using digital assets. The platform requires no merchant integration and users can complete purchases within a matter of minutes.

Advantageously, CoinLinked may profits off of transaction fees and offers tokenized memberships to unlock unique perks and benefits for users. As described herein, CoinLinked achieves a seamless cryptocurrency dropshipping system, along with a robust social networking platform that allows users to monetize their social and shopping experience.

By combining an intuitive drop shipping solution with a robust rewards system, users can experience a simplified digital asset spending experience while online merchants continue to receive fiat currencies they are comfortable accepting.

In one embodiment, using the systems and methods provided herein, global users (e.g., buyers, users, purchasers, etc.) are not required to open independent profiles and/or accounts with marketplaces around the world to transact in fiat currency. Instead, users may perform blockchain-based digital currency transactions with any marketplace around the world using the platform described herein.

Advantageously, CoinLinked can be used to purchase online goods from any merchant anywhere in the world. CoinLinked also provides a simple copy and paste portal when it comes to purchasing online products. Consumers simply paste a link to their desired good into the CoinLinked portal and we use Application Programming Interfaces (APIs) to convert the total price into an equivalent amount of cryptocurrency. CoinLinked does not rely on merchants to integrate a new payment solution as consumers pay with cryptocurrencies and merchants receive local fiat.

Furthermore, CoinLinked offers a variety of unique opportunities to benefit from the continued usage of the platform. In one embodiment, users can save on service fees and shipping costs when earning our native credits, CLC, for example.

The platform's security token, CLS, provides a web 3 membership experience in which benefits are unlocked by holding tokens. Unlike traditional memberships where users incur sunk costs, with CoinLinked a user is free to come and go as they please. In one embodiment, memberships simply provide an added layer of benefits while the core service is free and accessible for anyone to use.

In one embodiment, CoinLinked may be the party responsible for ensuring that a user's cryptocurrency is seamlessly converted to fiat currencies and paid to the merchant the user is requesting to purchase something from.

Advantageously, the systems and methods described herein allow buyers to maintain anonymous because purchases are conducted through the platform, using anonymous blockchain based digital currency instead of directly with the marketplace. In one embodiment, the platform described herein (e.g., “CoinLinked”) receives authorization from a buyer to facilitate transaction with a third party (e.g., an online marketplace), determines an amount of digital currency to facilitate the transaction in fiat currency, requests the digital currency from the buyer, and executes the transaction with the third party in fiat currency on behalf of the buyer. In one embodiment, buyer shipping information received by CoinLinked may be used to execute the transaction with the third party. In one embodiment, CoinLinked may be listed as the sender of any package, meaning that a user can send anonymous gifts to anyone of their liking.

In one embodiment, data stored by the platform may be stored in a data custody server, which may be external to the CoinLinked platform. Advantageously, such data custody servers protect user privacy by maintaining security and anonymity.

As described herein, CoinLinked is a private and secure decentralized monetizing social network. CoinLinked incorporates innovative technologies that solve key privacy problems of social networks. In one embodiment, CoinLinked does not collect any identifying data regarding user interests, preferences, habits, purchases, etc. In one embodiment, CoinLinked may collect anonymous data relating to various components of the platform and associated operations. CoinLinked may not store individual user's messaging history (e.g., the platform uses P2P encrypted messaging).

In one embodiment, CoinLinked is a decentralized social network of which all data and multimedia uploads are stored within the encrypted decentralized storage solution (e.g., data custody) that is built and maintained separately from the CoinLinked platform. CoinLinked may be a privacy social network, as the platform ensures all users data is encrypted to prevent unauthorized viewing and does not allow search engines to index user profiles. CoinLinked may utilize privacy settings that enable users to control who can see their profile and personal data.

In one embodiment, CoinLinked is a secured social network, as the platform security incorporates a two-factor authentication (e.g., an extra layer of protection used to ensure the security of user profile beyond just a username and password) and AI-based external identity user validation services. CoinLinked is a blockchain social network platform with new business models based on smart contracts and decentralized applications (dApps). This enables the implementation of cryptocurrency transactions, a token distribution reward system, and creation of an internal tokenized marketplace.

In one embodiment, CoinLinked is a cryptocurrency social network platform in which users can earn reward points which can be redeemed, exchanged, and/or used to purchase digital platform security tokens at a discounted price. Such use of cryptocurrency simplifies buying, selling, and other transactions on the platform. In various embodiments, tokens issued by the platform can be traded outside of the platform on cryptocurrency exchanges.

In one embodiment, CoinLinked is a monetization social network in which third-party marketplaces may be closely integrated with the platform, such that global users/buyers may utilize the platform to purchase anything, from anywhere, around the world utilizing cryptocurrencies (e.g., Bitcoin, Litecoin, Ethereum, etc.). Advantageously, the embodiments described herein provide for the creation of a reputation-based market for user-to-user goods, content, and platform features or services.

CoinLinked is a new-age decentralized blockchain social monetization network where users can:
earn cryptocurrency reward points
redeem, convert, and/or purchase, using reward points, issued CoinLinked Coin (CLC) at a discounted price
monetize their online activities with real decentralized blockchain verified value
exchange both reward points and CLC between other users on the platform/network
consumers can use CLC outside of our network
consumers can use CLC to pay for services and get discounts for services inside our network
Buy Products & Services with Top Crypto Currencies (i.e. Bitcoin, Ethereum, Litecoin, etc.) without middleman & banks on almost Any Internet Store in the World keeping full Anonymity and Security

Users may earn financial rewards and monetize their online activities in a variety of ways. At all hours of the day and night, users on social media are performing a variety of actions, such as browsing, searching, and posting their own content or liking/commenting/sharing the content of other users. CoinLinked provides a way to get rewarded for publishing a user's own posts, photos and videos, receiving many likes, etc. CoinLinked taps into its own pool of available cryptocurrency. CoinLinked coins (CLC, stored in the CoinLinked reward pool) can be exchanged/redeemed/purchased to the users receiving reward points.

In essence, using the methods and systems provided herein, users become an owner of digital value that can be used for other services in the network, outside the network, or stored in their own private blockchain crypto wallet. The blockchain is an incorruptible digital ledger of not only economic transactions, but virtually everything of value. In CoinLinked, this value could be generated based on user's activity or purchased/exchanged from other type of values in and outside the network. Blockchain makes it possible to record ownership publicly on a distributed ledger.

CoinLinked uses blockchain technology for its reward mechanism and to decentralize its finance value as much possible. Examples of financially incentivized processes include, for example:
Receiving reward points. Whenever a user is rewarded through the CoinLinked upvote system, the transaction is recorded on the blockchain.
Sending CLC to another user. This feature finally makes true micropayments between friends a reality.
Buying a product in any internet store (e.g., online marketplace) with cryptocurrency. In this case, the user is interacting with an Ethereum (or other) blockchain.
Exchanging CLC against fiat or other cryptocurrencies. Users are able to exchange CLC for fiat or for other cryptocurrencies directly through Coinlinked's wallet or using cryptocurrency exchanges.

In one embodiment, CLC is a digital coin designed to receive earnings/rewards monetizing a user's online life. They may be used for payments inside and outside the network, using blockchain technology. They may also be used for exchanging value, such as money or virtual money, between different parties without a middleman, over a blockchain that requires a digital currency.

In one embodiment, CLC utilizes its own easy to use cryptocurrency. It may be used to pay for goods and services rather than traditional money. CLC may be thought of as the native currency of the platform instead of using multiple different currencies that usually come with conversion and middleman fees. It works as an advanced loyalty program as well as a standalone cryptocurrency.

In one embodiment, the CLC Coin is an ERC20 based token on the Ethereum blockchain. CLC can be stored in any ERC20 compatible wallet. In other embodiments, other blockchain based technologies, such as Bitcoin, may be used. CoinLinked may also be the best place to purchase or earn CLC coins, although they may be purchased on EtherDelta and/or other platforms. If a user decides to pull their CLC from the exchange, any ERC-20-compatible wallet, such as MyEtherWallet and Coinomi may be used, or the user can hold CLC coin in their own wallet.

In one embodiment, the entire wallet may be built using a smart contract coded in Solidity on the Ethereum blockchain. In other embodiments, any other suitable platforms may be used. The smart contract generates a user's wallet and it will be stored in the database. Since the wallet is generated from a smart contract, it will not have a private key, so CoinLinked will not have to store private keys. Instead, the user creates a password that grants them access to their wallet. Whenever a transaction requires signing (e.g., for a send), the user simply enters their password and the smart contract checks if the user should be granted access. A user password may first be hashed and salted before sending to the smart contract, as it will be displayed publicly on the blockchain. This is a far more decentralized solution than hosting and encrypting private keys like a majority of exchange and application wallets.

CoinLinked may supply all accounts with a decentralized wallet to securely store CLC and other popular cryptocurrencies. Account wallets may exist within a series of smart contacts on the Ethereum blockchain (or some other platform), making it completely decentralized and uncontrollable from anyone other than the wallet's creator.

CoinLinked account wallets may be created through a decentralized smart-contract process, for which there is no owning entity. The setup entity, being CoinLinked, will not have control over any funds kept in a user's account wallet and will not be able to process any transactions on behalf of the user—making it completely decentralized. Process:
Onboarding process
Prompt user to create password to access wallet
Function returns new wallet address
CoinLinked saves wallet address in DB for reference only

CoinLinked uses blockchain to decentralize and provide anonymity. Blockchain operates with no central authority. As such, Blockchain allows CoinLinked to make and verify transactions—without a single governing body making sure everything is proper. Meanwhile, if a user is paying with a blockchain-based currency, the transaction is just between the user and the receiver. When one copy of the blockchain ledger gets changed, nodes on the blockchain verify the transaction before adding it to their own ledgers. Advantageously, blockchain is faster than the alternative, because everybody involved doesn't have to wait on a single, slow-moving source for verification. It all happens simultaneously. Using blockchain may speed up transactions while cutting costs associated with third-party banks and lowering the risk of fraud. That means more speed, affordability, and security for everyone.

The platform described herein allows for a user to buy any product in the world anonymously with crypto currency via CoinLinked. A described herein, if a user wants to buy a product from an online marketplace, the user provides CoinLinked a link to the product. The user pays with a cryptocurrency or with CLC and gets the product shipped to their house. This may eliminate the need for middlemen, banks, credit cards, and other third-party payment authorities, services and/or companies and all their fees. A user provides a request to CoinLinked that identifies what the user wants, uses their blockchain crypto wallet, and get their product. There is no need in any account with any online marketplace, and no verification. Furthermore, the purchase is fully anonymous. No one will be able to determine where the user obtained Crypto Money, how much the user paid, what products or services they buy, where it gets shipped.

A user simply processes the transaction for the product on CoinLinked and the transaction gets recorded on blockchain, and CoinLinked verifies the transaction via blockchain. Using blockchain in CoinLinked essentially cuts out the middleman, provides this ability while cutting costs associated with third-party banks and authorities, lowering the risk of fraud. That means more speed, affordability, comfort, security and anonymity for everyone.

Worth noting, although the embodiments described herein refer to costs, prices, exchanges, etc., the embodiments described herein, at their core, describe a practical application of blockchain technology that is necessarily rooted in the technology itself. For example, the embodiments described herein provide technological advancements that allow a computer system running the embodiments to execute specific transactions on behalf of other computer systems that are incapable of executing the required transactions. Furthermore, the embodiments described herein improve computer-system functionality itself, as they enable quicker and more efficient (e.g., from a power perspective) processing of cryptocurrency transactions.

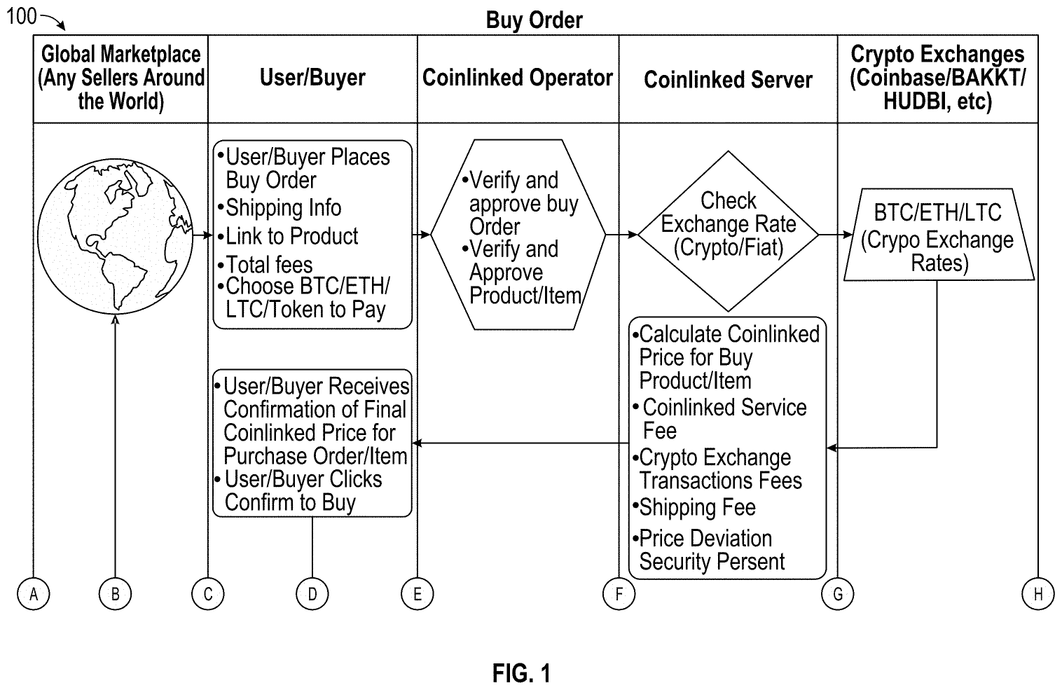

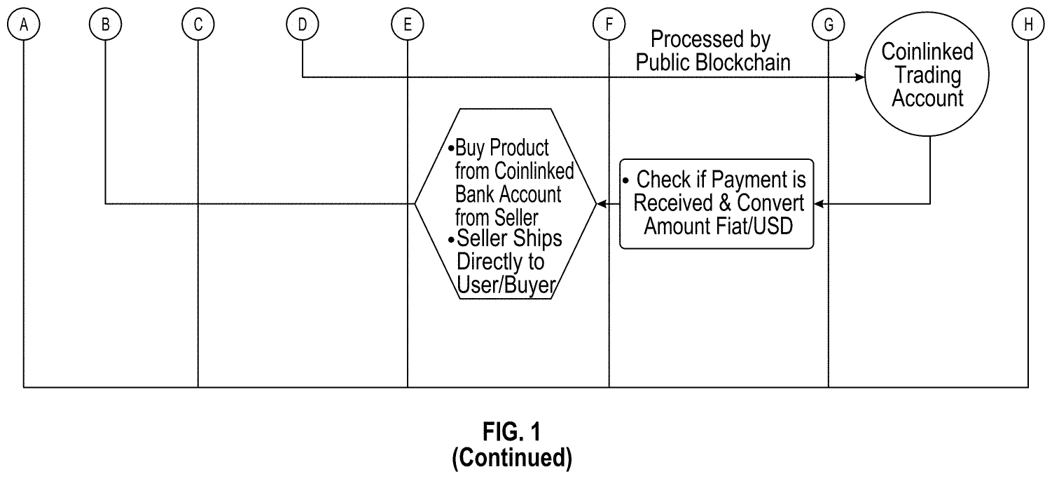

FIG. 1 illustrates a flow diagram of a buy order method 100 of a blockchain-based payment system, according to one embodiment. The method 100 may be performed by processing logic that comprises hardware (e.g., circuitry, dedicated logic, programmable logic, microcode, etc.), software (e.g., instructions run on a processing device to perform hardware simulation), or a combination thereof.

Referring to FIG. 1, the blocks of method 100 illustrate the operations of facilitating an order on the platform described herein (e.g., the CoinLinked server). In one embodiment, a user places an order, for an item on a third-party marketplace, on a client device (e.g., a computer, tablet, mobile phone, smartwatch, etc.). The order may be received by the CoinLinked server and verified.

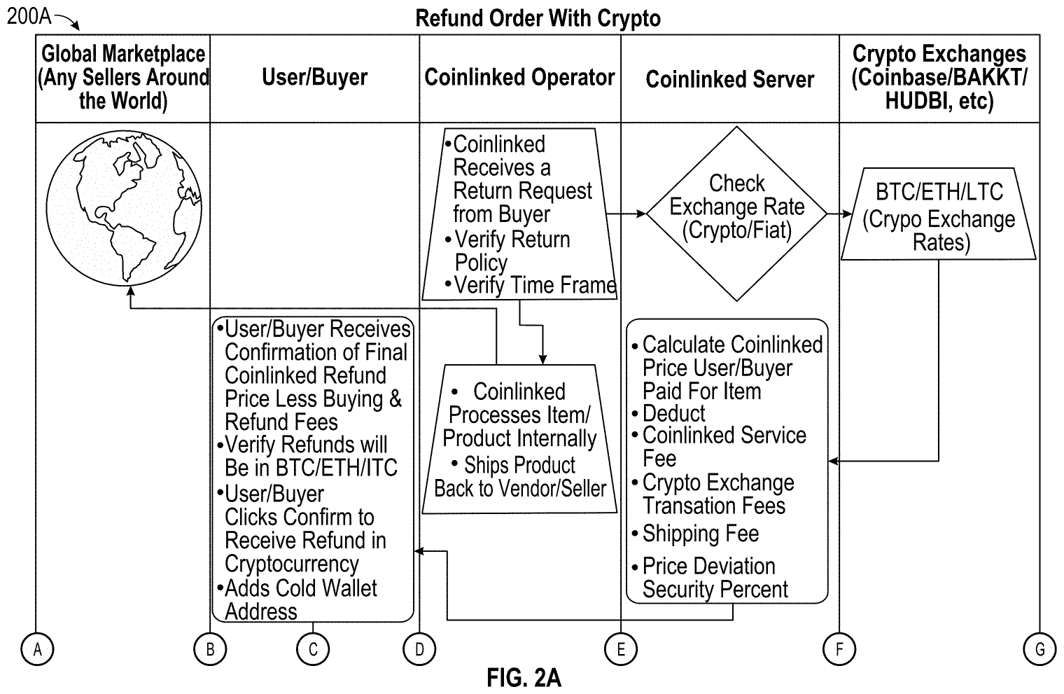

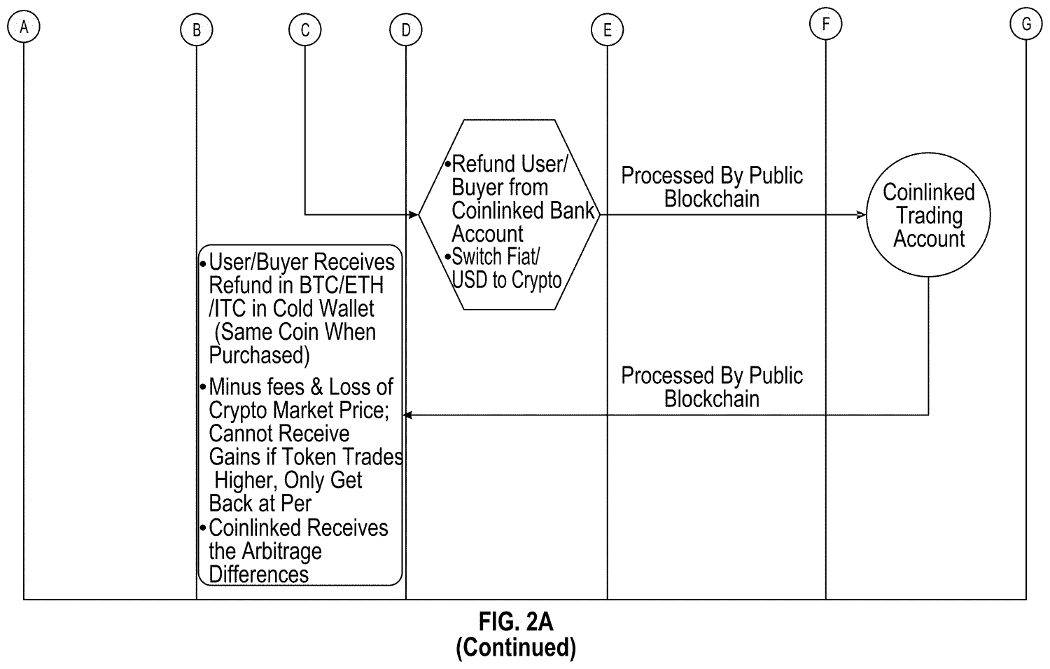

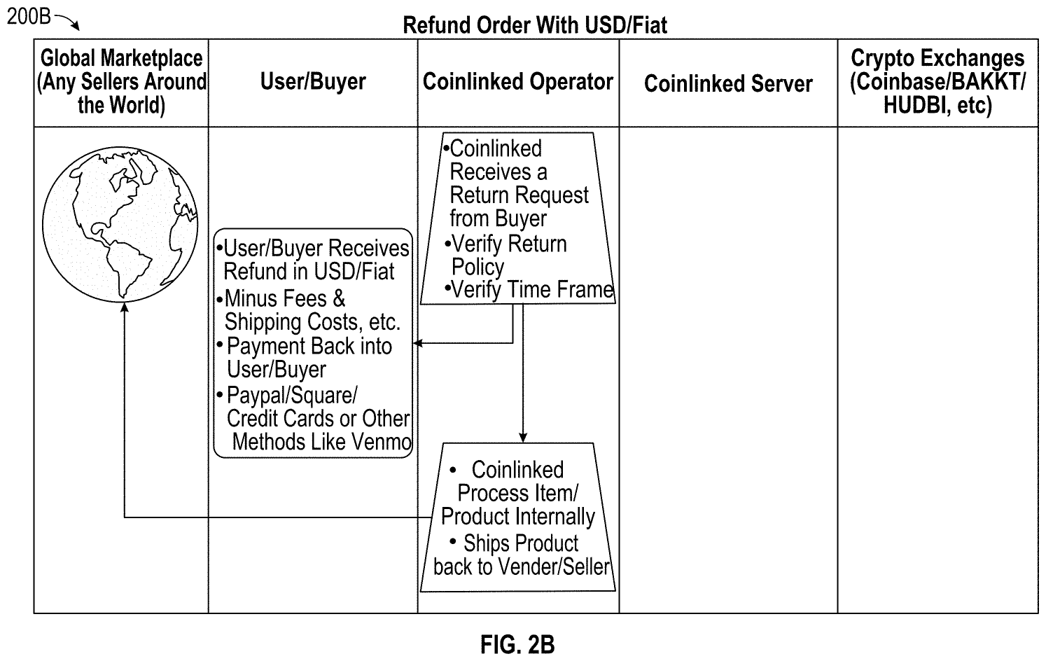

Processing logic of the server determines an exchange rate for the cryptocurrency, which the user is to provide, and the currency accepted by the third-party marketplace (e.g., a fiat currency). In one embodiment, the CoinLinked server communicated with one or more crypto exchanges to determine the exchange rate. Once determined, the CoinLinked server may determine an order total in the cryptocurrency, including the price of the item to be purchased and any service and shipping fees. In one embodiment, a commission for the sale and/or refund (see FIG. 2) may be charged to the user.

The CoinLinked server may generate an order form for the item and send the form to the client device for acceptance. When an acceptance of the order and payment (in cryptocurrency) is received by the CoinLinked server, the CoinLinked server may process the order on the third-party marketplace on behalf of the user, using the currency accepted by the third-party marketplace. In one embodiment, the user agrees to purchase the item from CoinLinked, with CoinLinked acting as a drop-shipper. In another embodiment, the user purchases the item directly from the third-party marketplace, with CoinLinked acting as a currency exchanger. In such a case, CoinLinked may operate with a money transmitter license.

FIGS. 2A and 2B illustrate first and second flow diagrams of a refund method 200A and 200B of a blockchain-based payment system, according to one embodiment. The methods 200A and 200B may be performed by processing logic that comprises hardware (e.g., circuitry, dedicated logic, programmable logic, microcode, etc.), software (e.g., instructions run on a processing device to perform hardware simulation), or a combination thereof.

In one embodiment, the blocks of methods 200A and 200B illustrate the operations of returning an order on the platform described herein (e.g., the CoinLinked server). In one embodiment, after determining that a third-party seller accepts returns, processing logic of the CoinLinked server determines an exchange rate (e.g., from one or more crypto exchanges) for the cryptocurrency to be returned to the buyer, and the currency returned by the third-party marketplace (e.g., fiat currency). Once determined, the CoinLinked server may calculate the return amount in cryptocurrency, minus any service fees and/or nonrefundable fees from the third-party marketplace. A form may be generated and sent to the user for acceptance. Once accepted, the refund may be facilitated with the third-party marketplace and the amount of cryptocurrency determined by the CoinLinked server may be refunded to the user. In one embodiment, the return process may be handled completely internally (as shown in FIG. 2B).

As described above, in one embodiment, a commission for the sale and/or refund may be charged to the user. The buyer may receive a refund less all fees when he or she bought the order and less all fees when he's asking for a refund. That may include an adjustment for market fluctuation. In regards to market fluctuation, at the time of the refund, if cryptocurrency prices are higher than when the order was originally processed, CoinLinked may keep the difference. The lower amount may be refunded to the user, which was the amount that was used to place the buy order. In the event that cryptocurrency prices fall below the price when the order was placed, the buyer may receive that market price (which is below the price when he placed the buy order) in return.

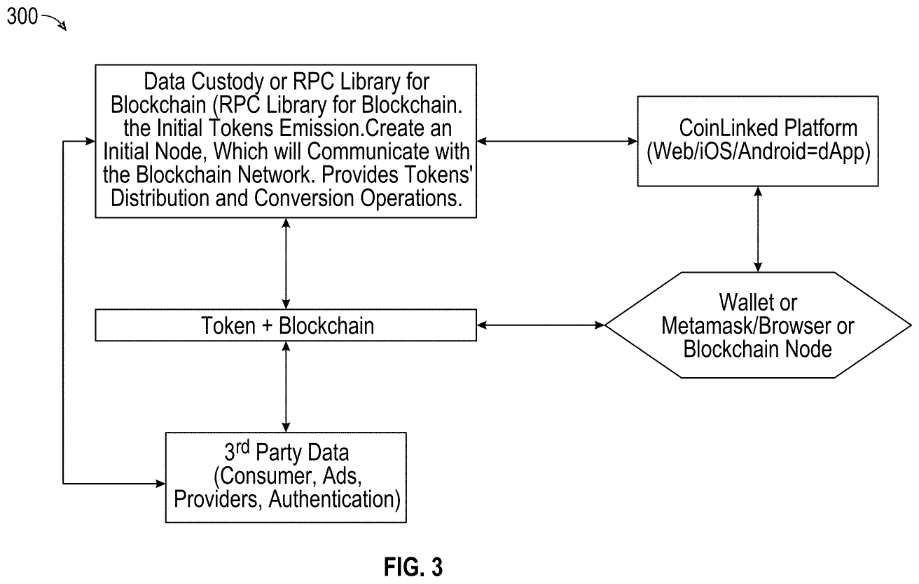

FIG. 3 illustrates a flow diagram of a data custody method 300 of a blockchain-based payment system, according to one embodiment. The method 300 may be performed by processing logic that comprises hardware (e.g., circuitry, dedicated logic, programmable logic, microcode, etc.), software (e.g., instructions run on a processing device to perform hardware simulation), or a combination thereof. Processing logic of method 300 may store data from the CoinLinked platform on a data custody server according to the operations described in FIG. 3.

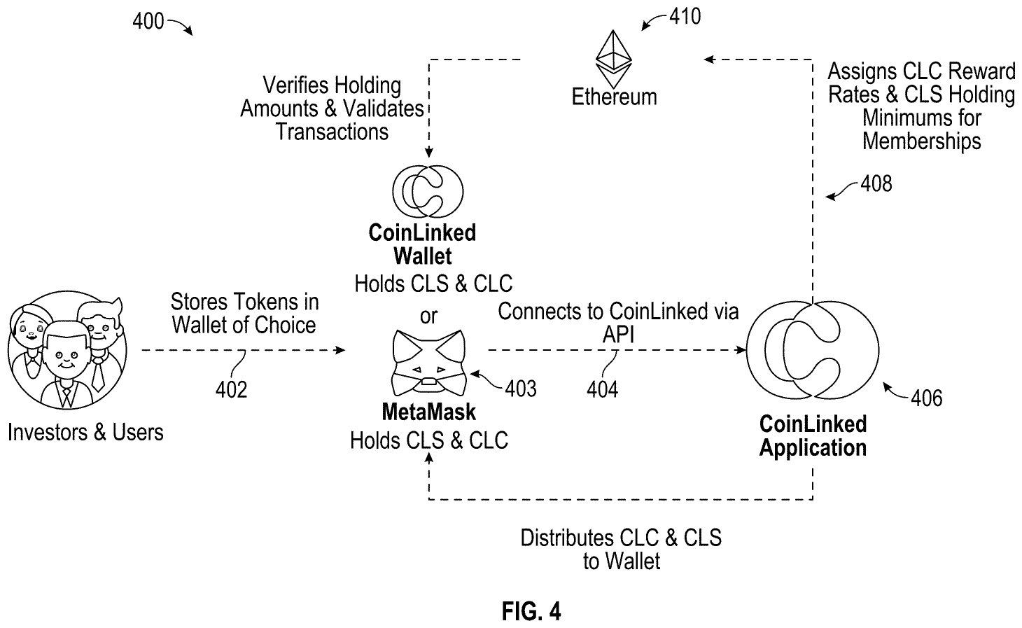

FIG. 4 illustrates an example token economy system and method 400 of a blockchain-based exchange platform, according to one embodiment. In one embodiment, the CoinLinked ecosystem is powered through a dual token model featuring both a security token and a utility token. Given the current regulatory environment, a clear distinction between which is serving as an investment vehicle versus a tokenized rewards and incentive program may be advantageous.

In one embodiment, CoinLinked Security Tokens (e.g., CLS) may be Ethereum-based ERC1400 assets representing Class C common shares in CoinLinked Inc. They may be the primary fundraising vehicle in which capital may be raised through a primary offering. Ownership of CoinLinked Security Tokens may grant holders a multiple of benefits within the platform including but not limited to: equity in an entity (e.g. CoinLinked, Inc.), potential for dividends, and CoinLinked memberships.

In one embodiment, CoinLinked Security Tokens (CLS) represent equity in the Company. This equity may be classified as common shares. In another embodiment, a holder of CLS tokens may be entitled to receive a quarterly pro-rata distribution of net profits. Cash flows may be paid out directly to the wallets in which CLS is being held. In yet another embodiment, users can purchase a CoinLinked membership by holding CoinLinked Security Tokens (CLS). Any holder with more than the required USD equivalent (e.g., $199 CLS) in their CoinLinked wallet may automatically qualify for Tier B membership benefits, waiving service fees and accessing free shipping, for example.

In one embodiment, users can unlock CoinLinked memberships by holding $199 of CoinLinked Security Tokens (CLS), or any other suitable threshold. Memberships may be triggered if the user purchases $199 of CLS at that point in time. Any fluctuations in the price of CLS may not affect the user's membership status, so long as they either hold in excess of >$199 in CLS or hold the same amount of tokens at purchase. If at any point a user sells or moves its tokens out of their CoinLinked wallet and the total value held drops below the threshold, the membership may be canceled.

Advantageously, tokenized memberships are the future of business subscriptions. Unlike traditional memberships which cause users to incur sunk costs (i.e. paying $10/month for Amazon Prime, for example), tokenized memberships are valid for as long as the user keeps tokens in their wallet. CoinLinked memberships require no monthly or annual payment while tokens can be bought and resold on secondary markets.

CoinLinked Memberships will allow users to benefit from unique perks and features on the platform. These perks will include, but are not limited to: no service fee and free or discounting shipping. For example, with respect to service fees, users with a CoinLinked membership may not be charged a service fee. As such, the only cost incurred is the face value of the goods being purchased and network transaction fees. On networks like Ethereum, each transaction incurs a small fee (most commonly known as gas) to process the request. CoinLinked's service fee may be charged separately from the underlying network transaction fee.

With respect to shipping, users with a CoinLinked membership may have access to free or discounted shipping within the United States, for example. Each month, free shipping costs may be limited to a set amount of dollars which can be waived in the event that user earns a certain threshold of CLC tokens. Any members who are inactive (i.e. not accruing CLC) may have a monthly limit on shipping costs.

In one embodiment, CoinLinked credits (e.g., CLC) may be an in-app Ethereum-based ERC20 utility token. In one embodiment, they may not be sold at any point and will only be rewarded through usage of the platform described herein. CoinLinked Credits use cases will include but are not limited to: usage rewards, service fee reductions via burning, and shipping discounts via holding.

In one embodiment, CoinLinked users may have a variety of ways to earn CLC by interacting with the platform. For example, social users may have the opportunity to earn CoinLinked Credits (CLC) by posting and curating content on the CoinLinked website. Rewardable actions within the CoinLinked platform may include, but are not limited to:
Successfully registering on CoinLinked
Referring new users
Passing KYC/AML
Completing your first purchase on CoinLinked
Connecting CoinLinked other social platforms (e.g., Twitter, Instagram, Facebook)
Videos having more than X views
Posts reaching more than X likes
Subsequent CoinLinked purchases
Submission for a verified profile
Making X new video posts on CoinLinked
Making X new posts on CoinLinked
Creating a top 10 “trending” post
Receiving a “like” on a social post

In one embodiment, CLC can be used to minimize a fee charged on all CoinLinked purchases. As such, users may have the ability to cover up to 100% of the CoinLinked fee on a transaction by transaction basis. As an example: Bob wishes to purchase a new Chromebook for $150 and wishes to pay in Bitcoin ($BTC). Based on a spot rate of 1 BTC=$10,000 and a 2.5% service fee, Bob's transaction may cost the following:

| Cost | USD Value | BTC Value |
|---|---|---|
| Chromebook | $150 | 0.015 |
| CoinLinked Service Fee (2.5%) | $3.75 | 0.000375 |
| Bitcoin Transaction Fee | $1 | 0.0001 |
| Shipping | $10 | 0.001 |
| Total | $165.75 | 0.016575 |

Using the CoinLinked Credit System, Bob may spend up to $3.75 worth of CLC to waive the Service Fee, bringing his new total to $162.5 or 0.01625 BTC. In one embodiment, CLC used to reduce fees may be split between being burned (50%) and sent to the CoinLinked Reserve (50%).

Furthermore, by implementing CLC, CoinLinked enables a native mechanism for users to tip content creators. Tipping has seen a growing interest among major platforms including Twitter and other content creation platforms like Twitch.TV. Advantageously, the addition of tipping via CLC may drive additional incentives for users to post on the platform and drive meaningful, quality engagement on the platform.

Referring to FIG. 4, users may store tokens in a wallet 403 of their choice at block 402. Examples may include a CoinLinked wallet or a MetaMask wallet, for example. In one embodiment the selected wallet 403 connects to the CoinLinked platform 406 via an API at block 404. The CoinLinked platform 406 may distribute security tokens and credits back to the wallet of choice 403. In another embodiment, the CoinLinked platform 406 assigns 408 credit rewards rates and token holding memberships via Ethereum 410, for example, which subsequently verifies holding amounts and validates transactions 412 back to the wallet 403.

Additionally, CLC can be spent to mitigate shipping costs (e.g., up to a determined cap) on all CoinLinked purchases on a transaction by transaction basis. As an example: Using the same Chromebook example above, the product cost $150. Based on a spot rate of 1 BTC=$10,000 and a 2.5% service fee, Bob's transaction will cost the following:

| Cost | USD Value | BTC Value |
|---|---|---|
| Chromebook | $150 | 0.015 |
| CoinLinked Service Fee (2.5%) | $3.75 | 0.000375 |
| Bitcoin Transaction Fee | $1 | 0.0001 |
| Shipping | $10 | 0.001 |
| Total | $165.75 | 0.016575 |

Using the CoinLinked Credit System, Bob may spend up to $2 worth of CLC (or 20% of the $10 shipping costs), bringing his new total to $164.25. In one embodiment, CLC used to mitigate shipping costs will be split between being burned (50%) and sent to the CoinLinked Reserve (50%).

In one embodiment CoinLinked Credits may be issued upon the execution of specific reward actions described above. In this sense, community members may bootstrap the supply through organic usage of the platform. In one embodiment, CoinLinked Inc. will not sell any CLC in an ICO and all tokens will be distributed using a smart contract, thus mitigating the risk for centralized control. In this sense, the supply and demand of CLC may be entirely dictated by the community in a peer-to-peer fashion.

In practice, rewards may be issued at a marginally decreasing rate, effectively meaning that early adopters may likely earn the largest rewards for their contributions to the platform. As the platform continues to scale, an issuance schedule that is offset by the amount of CLC being burned and staked for redemptions and memberships may be created. Tokens may be effectively burned when they are sent to the official Ethereum burn address (0x000000000000000000000000000000000000dead), for example.

In one embodiment, CoinLinked Inc. may collect 50% of CLC when tokens are burned for service fees and shipping cost mitigation. As such, 50% CLC tokens used to mitigate service fees may be removed permanently from the circulating supply while the other 50% is retained by CoinLinked. In one embodiment, these tokens may be held in an internal reserve and may be used by CoinLinked Inc. in any suitable fashion.

In one embodiment, users who are caught leveraging bots and other fake engagement methods to obtain CLC may have their CLC invalidated and may be subject to account suspension or banning. Similarly, CoinLinked Security Token (CLS) holders caught attempting to fraud the system will also be subject to similar actions.

In one embodiment, CoinLinked may operate differently than other online stores. CoinLinked fulfills the order from other merchants who act as the Company's suppliers. After a user orders, the CoinLinked will purchase the product and arrange drop shipping to the user. At the time the user pays, the CoinLinked is contractually obligated to fulfill your order subject to availability. Accordingly, some orders may not be fulfilled due to unavailability of the product. If CoinLinked cannot fulfill the order, the user will be refunded an amount equivalent in US dollar terms in the same manner that the user paid.

For example, if the user paid with cryptocurrency, the user will be refunded an equivalent amount of the same cryptocurrency unless the cryptocurrency to US dollar rate has decreased. In that instance, the user will receive more cryptocurrency. More specifically, the user will receive the cryptocurrency equivalent of what the user originally spent in dollar terms. For instance, if the user paid 1 Bitcoin for a product when the exchange rate is one Bitcoin for $5,000 USD, and the exchange rate changes to one Bitcoin to 1 USD at the time of refund, then the user may receive 5,000 Bitcoins as a refund. However, if the exchange rate at the time of refund changes to 1 Bitcoin to $20,000 USD, then the user may receive 1 Bitcoin as a refund. In other words, CoinLinked may absorb the risk of a change in the cryptocurrency to USD exchange rate.

In one embodiment, the above policy is only in effect in the event CoinLinked cannot fulfill the user's order. If the user returns a product or service, the user will be refunded an amount in accordance with the below. When a user returns the product, the user, rather than the Company, may bear the risk of any change in the USD or other fiat currency to cryptocurrency exchange rate. For instance, in the above example, the event of refund when the cryptocurrency to US dollar exchange rate changes to 1 Bitcoin to $20,000 USD, then the user will only receive 0.25 Bitcoins.

A user may be refunded in the same manner that they paid. If the user paid with cryptocurrency, the user will be refunded in the same cryptocurrency. In this case, the user may bear the risk of any change in the dollar to the cryptocurrency exchange rate. If the cryptocurrency to US dollar rate has changed against the user, the user will receive the cryptocurrency equivalent of the dollar amount that you spent. In other words, the user will receive less cryptocurrency than he or she originally spent. For instance, if the user paid 1 Bitcoin for a product when the exchange rate is one Bitcoin for $5,000 USD and the user seeks a refund, then the user will receive $5,000 USD in Bitcoin.

If the exchange rate changes to one Bitcoin to 1 USD at the time of refund, then the user may receive 5,000 Bitcoins as a refund. Alternatively, if the exchange rate at the time of refund changes to 1 Bitcoin to $20,000 USD, then the user may receive 0.25 Bitcoins as a refund.

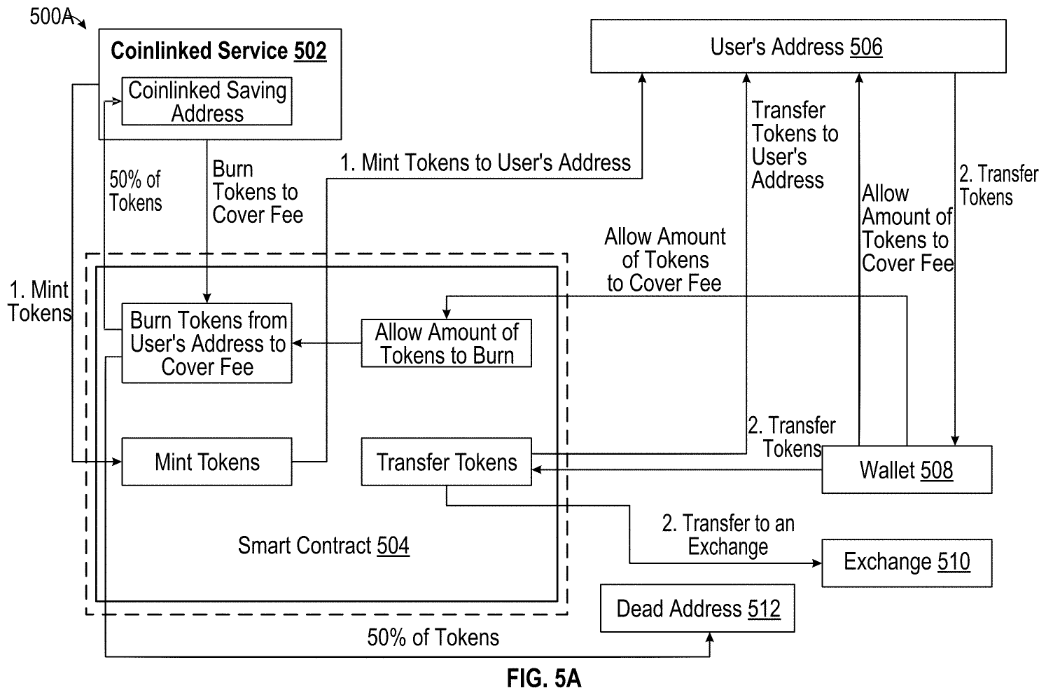

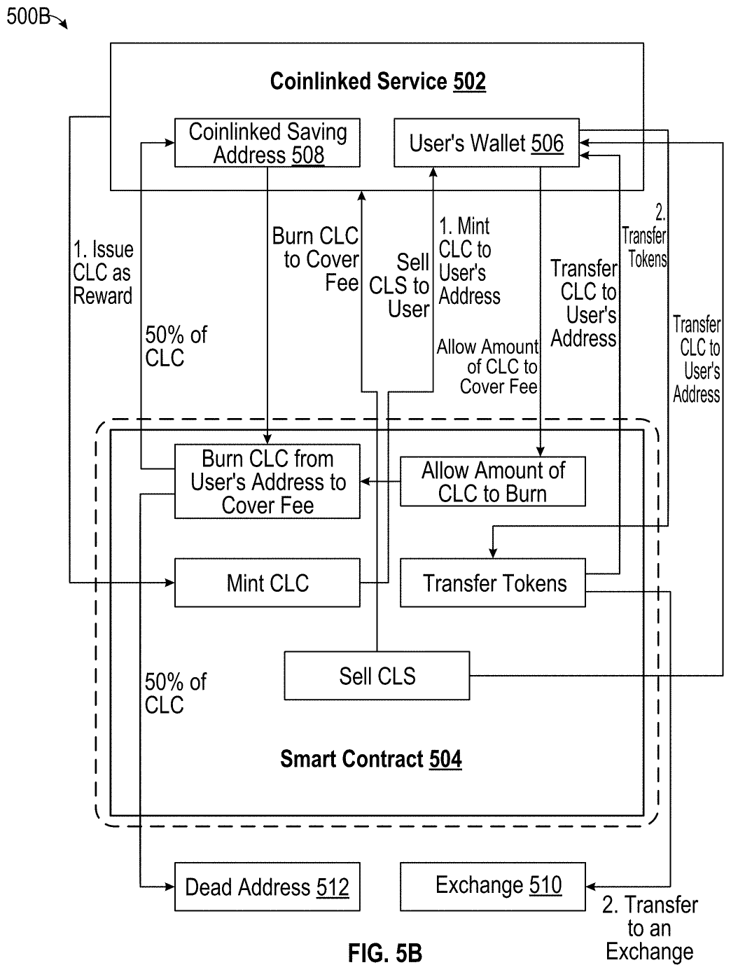

FIG. 5A illustrates a first system 500A and flow diagram of a token lifecycle, according to one embodiment. The operations of system 500A may be performed by processing logic that comprises hardware (e.g., circuitry, dedicated logic, programmable logic, microcode, etc.), software (e.g., instructions run on a processing device to perform hardware simulation), or a combination thereof.

Referring to FIG. 5A, system 500A may include a CoinLinked service 502, smart contract 504, user's address 506, cryptocurrency wallet 508, cryptocurrency exchange 510, and dead address 512. In one embodiment, processing logic of CoinLinked service 502 may perform operations that interact with the remaining components of the system 500A. Worth nothing, less or more components than those illustrated in system 500A are possible.

In one embedment, CoinLinked service 502 may mint tokens of the smart contract 504, and provide the tokens to the user's address 506 (e.g., of cryptocurrency wallet 508). Tokens may be transferred to cryptocurrency wallet 508 and may be allowed to cover fees associated with cryptocurrency wallet 508 and/or CoinLinked service 502. In one embodiment, tokens may be transferred from cryptocurrency wallet 508, via the smart contract 504, to the user's address 506. In another embodiment, tokens may be transferred, via smart contract 504, to a cryptocurrency exchange 510.

If tokens are used to cover a fee, such tokens may be burned under the smart contract 504. In one embodiment, in such a case, CoinLinked service 502 may retain a percentage (e.g., 50%) of the burned tokens with the remaining tokens sent to a dead address 512.

FIG. 5B illustrates a second system 500B and flow diagram of a token and credit lifecycle, according to one embodiment. The operations of system 500B may be performed by processing logic that comprises hardware (e.g., circuitry, dedicated logic, programmable logic, microcode, etc.), software (e.g., instructions run on a processing device to perform hardware simulation), or a combination thereof.

Referring to FIG. 5B, system 500B may include CoinLinked service 502, smart contract 504, cryptocurrency (user's) wallet 506, CoinLinked saving address 508, cryptocurrency exchange 510, and dead address 512. In one embodiment, processing logic of CoinLinked service 502 may perform operations that interact with the remaining components of the system 500B. Worth nothing, less or more components than those illustrated in system 500B are possible. Consistent with the disclosure, tokens may be referred to as CLS and credits may be referred to as CLC in the following non-limiting description and corresponding figure for brevity and clarity.

In one embodiment, processing logic of CoinLinked server 502 may issue credits (CLC) to a user as a reward, wherein the smart contract 504 mints the CLC and provides it to the user's cryptocurrency wallet 506 for storage.

CLC may be allowed to cover fees associated with cryptocurrency wallet 506 and/or CoinLinked service 502. If CLC is used to cover a fee, such CLC may be burned under the smart contract 504. In one embodiment, in such a case, CoinLinked service 502 may retain a percentage (e.g., 50%) of the burned tokens in the CoinLinked saving address 508 with the remaining tokens sent to dead address 512 to be invalidated. In another embodiment, CLC stored in CoinLinked saving address 508 may be burned under the smart contract 504 via the same process as described above.

In another embodiment, tokens (CLS) may be stored in user's wallet 506. In such a case, CLS may be sold to the user via the CoinLinked service 502 and transferred to the user's wallet 506 for storage under the smart contract 504. A user may transfer CLS under the smart contract 504, out of user's wallet 506, to: convert (e.g., purchase, trade, exchange, etc.) the CLS to CLC and store received the CLC in the user's wallet 506; or to transfer the CLS to an exchange 510.

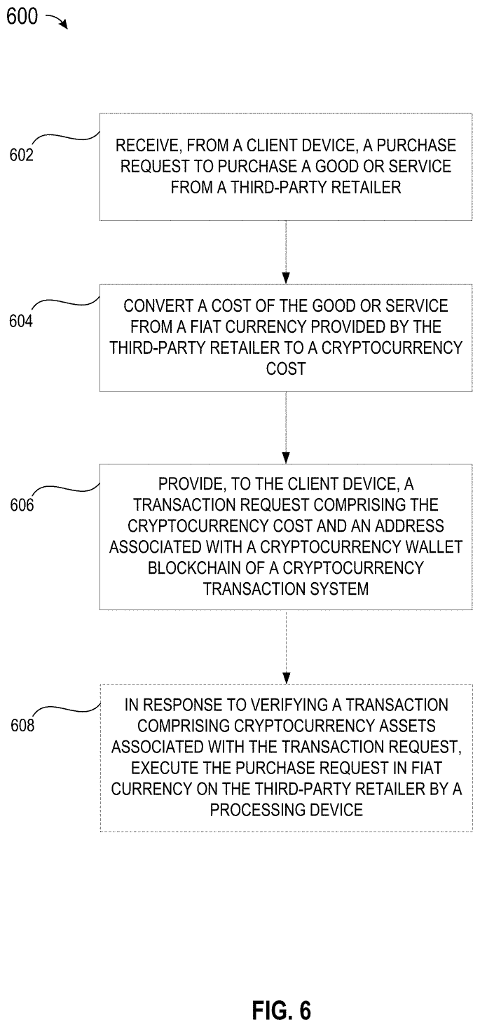

FIG. 6 illustrates a flow diagram 600 of a blockchain-based exchange, according to one embodiment. The method 600 may be performed by processing logic that comprises hardware (e.g., circuitry, dedicated logic, programmable logic, microcode, etc.), software (e.g., instructions run on a processing device to perform hardware simulation), or a combination thereof.

In one embodiment, if a user wishes to purchase an item online with Bitcoin using traditional methods, the process may be something like this:

1. Transfer the Bitcoin to an exchange like Coinbase or Gemini with fiat off-ramps
a. This may incur an average of ˜$2.50 from network fees
   2. Convert that Bitcoin to USD at a lower than market spot rate
a. Likely losing about 0.5% of the total value when accounting for market taker fees.
   3. Spend an additional fee for instantaneous withdrawal
a. Often times a percentage of the total or a flat fee around $10
   4. With no instant withdraws, expect to wait 2-7 business days for your bank to complete the process.
   5. Once the user finally receives the USD from selling your Bitcoin, expect to spend an additional 5-10 minutes creating a new account and entering all payment and shipping details.

Advantageously, using the systems, platforms, and methods described herein, the entire process can be simplified to:
Connect a cryptocurrency wallet to CoinLinked
Paste a link to a product or service on a third-party retailer
Choose a cryptocurrency payment method
Receive a quote in the selected cryptocurrency
Send a one-time payment to the cryptocurrency address provided
Confirm shipping details
Receive real-time updates
   In other embodiments, one or more of the above steps may be omitted.

Referring to FIG. 6, processing logic may perform one or more of the steps described above on a social commerce network associated with a cryptocurrency transaction system. For example, at block 602, processing logic receives, from a client device, a purchase request to purchase a good or service from a third-party retailer. In one embodiment, the request includes a Uniform Resource Locator (URL) (e.g., a “link” to the good or service). Optionally, before receiving the purchase request, processing logic may further connect a cryptocurrency wallet associated with a user of the client device to the social commerce network. In one embodiment, the purchase request includes a selected cryptocurrency payment method from a plurality of cryptocurrency payment methods, wherein the cryptocurrency cost corresponds to the selected cryptocurrency payment

At block 604, processing logic converts a cost (e.g., price) of the good or service from a fiat currency provided by the third-party retailer to a cryptocurrency cost (e.g., price, value, etc.). In one embodiment, to convert the fiat cost to the cryptocurrency cost, the processing device is to use an application programming interface (API).

At block 606, processing logic provides, to the client device, a transaction request including the cryptocurrency cost and an address associated with a cryptocurrency wallet blockchain of the cryptocurrency transaction system. Processing logic may be sent cryptocurrency assets in response to the cryptocurrency transaction system, and processing logic may verify the transaction with the received cryptocurrency assets.

At block 608, in response to verifying the transaction comprising the cryptocurrency assets associated with the transaction request, processing logic may execute the purchase request in fiat currency on the third-party retailer. Optionally, processing logic may provide an interface to the client device by which a user may verify shipping information, and provide the supplied shipping information to the third-party retailer for shipment.

In one embodiment, in response to verifying the transaction associated with the transaction request, the processing logic may further provide a social commerce network security token (e.g., CLS) or a credit (e.g., CLC) to the client device, wherein a value associated with the security token or credit is based on the cost of the good or service. In one embodiment, processing logic may receive a request to redeem the security token or credit and, in response to receiving the request, execute a transaction on the social commerce network as described herein.

As described herein, in addition to providing a seamless experience for digital asset e-commerce, CoinLinked may embed social commerce directly into the platform. In one embodiment, users can post and caption their purchases to share among their social network. Furthermore, CoinLinked may enable rewards when friends purchase a product or service based on the original user's post.

Some of the key highlights of our social marketplace include: incentives to share purchases among peers; the ability to earn discounts for usage of the platform; product curation to recommend goods and services to peers; and referral systems to link purchases back to the original poster.

In one embodiment, the integration of social commerce will enable more robust network effects, help bootstrap growth, and create stickiness amongst our user base as they'll be able to earn “cash-back” from their social network. Social commerce leverages online marketing strategies or retail models that incorporate peer-to-peer communication and established social networks to boost sales.

Furthermore, the combination of CoinLinked Social with CoinLinked Credits (CLC) creates an incentivized mechanism for social commerce, increasing reach and engagement on purchases across the board. In accordance with the above, processing logic may post information associated with the transaction to at least one of: a live feed of the social commerce network or a profile corresponding to a user of the client device.

In one embodiment, processing logic may further to provide a recommendation for additional goods or services to the client device, the recommendation based on the transaction. In some embodiments, recommendations may be provided to users other than the one who initiated the transaction and based on things other than the transaction. For example, recommendations may be provided to friends, friends of friends, whole social groups, etc. Recommendations may be based on purchase histories, profile information, geographical region, etc.

In one embodiment, processing logic may provide a referral credit to the client device, the referral credit based on an executed transaction of a referred user. The referral credit may include a social commerce network security token, credit, or other suitable incentive (e.g., discount, fiat currency, etc.). In one embodiment,

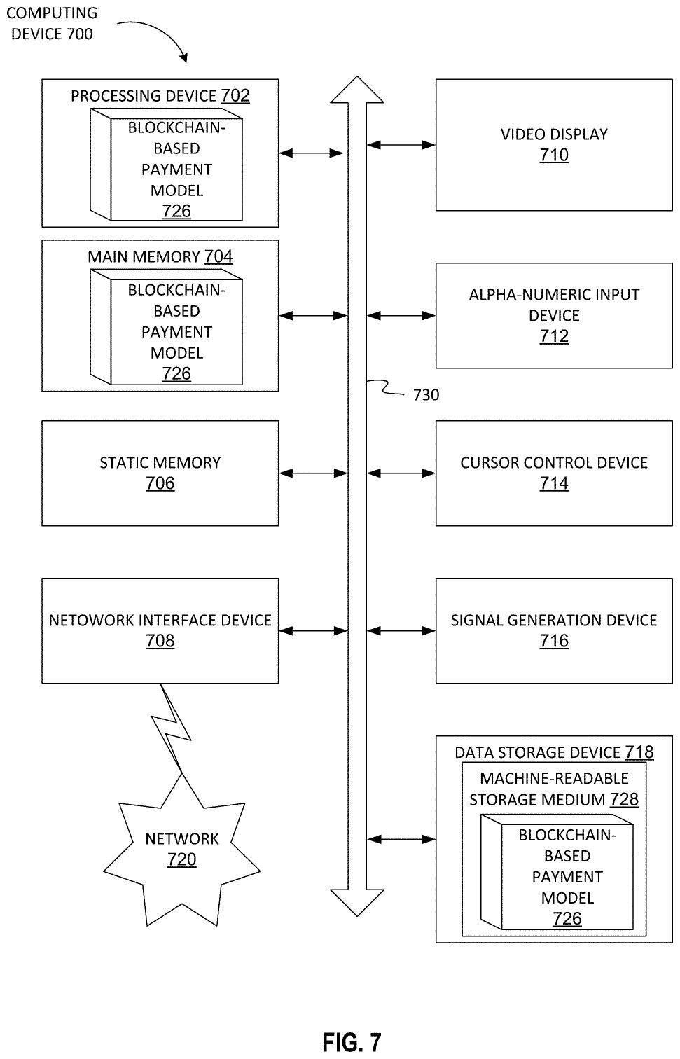

FIG. 7 is a block diagram of an example apparatus that may perform one or more of the operations described herein, in the example form of a computer system 700 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device 702, a main memory 704 (e.g., read-only memory (ROM), flash memory, dynamic random access memory (DRAM), a static memory 706 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute processing logic/instructions (e.g., blockchain-based payment model) 726, for performing the operations and steps discussed herein.

The data storage device 718 may include a non-transitory machine-readable storage medium 728, on which is stored one or more set of logic/instructions (e.g., blockchain-based payment model) 726 (e.g., software) embodying any one or more of the methodologies of functions described herein, including instructions to cause the processing device 702 to execute operations described herein. The logic/instructions (e.g., blockchain-based payment model) 726 may also reside, completely or at least partially, within the main memory 704 or within the processing device 702 during execution thereof by the computer system 700; the main memory 704 and the processing device 702 also constituting machine-readable storage media. The logic/instructions (e.g., blockchain-based payment model) 726 may further be transmitted or received over a network 720 via the network interface device 708.

While the non-transitory machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof

What is claimed is:

1. A social commerce network associated with a cryptocurrency transaction system, the system comprising:
a memory to store cryptocurrency assets; and
a processing device, operatively coupled to the memory, the processing device to:
receive, from a client device, a purchase request to purchase a good or service from a third-party retailer;
convert a cost of the good or service from a fiat currency provided by the third-party retailer to a cryptocurrency cost;
provide, to the client device, a transaction request comprising the cryptocurrency cost and an address associated with a cryptocurrency wallet blockchain of the cryptocurrency transaction system; and
in response to verifying a transaction comprising the cryptocurrency assets associated with the transaction request, execute the purchase request in fiat currency on the third-party retailer.

2. The system of claim 1, wherein the request comprises a Uniform Resource Locator (URL).

3. The system of claim 1, wherein to convert the fiat cost to the cryptocurrency cost, the processing device is to use an application programming interface (API).

4. The system of claim 1, wherein before receiving the purchase request, the processing device further to connect a cryptocurrency wallet associated with a user of the client device to the social commerce network.

5. The system of claim 1, wherein the purchase request comprises a selected cryptocurrency payment method from a plurality of cryptocurrency payment methods, and wherein the cryptocurrency cost corresponds to the selected cryptocurrency payment method.

6. The system of claim 1, in response to verifying the transaction associated with the transaction request, the processing device further to provide a social commerce network security token to the client device, wherein a value associated with the security token is based on the cost of the good or service.

7. The system of claim 6, the processing device further to:
receive a request to redeem the security token; and
in response to receiving the request, execute a transaction on the social commerce network.

8. The system of claim 1, the processing device further to post information associated with the transaction to at least one of: a live feed of the social commerce network or a profile corresponding to a user of the client device.

9. The system of claim 1, the processing device further to provide a recommendation for additional goods or services to the client device, the recommendation based on the transaction.

10. The system of claim 1, the processing device further to provide a referral credit to the client device, the referral credit based on an executed transaction of a referred user.

11. The system of claim 10, wherein the referral credit comprises a social commerce network security token.

12. A method of executing a transaction on a social commerce network associated with a cryptocurrency transaction system, comprising:
receiving, from a client device, a purchase request to purchase a good or service from a third-party retailer;
converting a cost of the good or service from a fiat currency provided by the third-party retailer to a cryptocurrency cost;
providing, to the client device, a transaction request comprising the cryptocurrency cost and an address associated with a cryptocurrency wallet blockchain of the cryptocurrency transaction system; and
in response to verifying a transaction comprising cryptocurrency assets associated with the transaction request, executing the purchase request in fiat currency on the third-party retailer by a processing device.

13. The method of claim 12, wherein before receiving the purchase request, the method comprises connecting a cryptocurrency wallet associated with a user of the client device to the social commerce network.

14. The method of claim 12, wherein the purchase request comprises a selected cryptocurrency payment method from a plurality of cryptocurrency payment methods, and wherein the cryptocurrency cost corresponds to the selected cryptocurrency payment method.

15. The method of claim 12, wherein in response to verifying the transaction associated with the transaction request, the method further comprises providing a social commerce network security token to the client device, wherein a value associated with the security token is based on the cost of the good or service.

16. The method of claim 15, the method further comprising:
receiving a request to redeem the security token; and
in response to receiving the request, executing a transaction on the social commerce network.

17. The method of claim 12, the method further comprising posting information associated with the transaction to at least one of: a live feed of the social commerce network or a profile corresponding to a user of the client device.

18. The method of claim 12, the method further comprising providing a recommendation for additional goods or services to the client device, the recommendation based on the transaction.

19. A social commerce network associated with a cryptocurrency transaction system, the system comprising:
a cryptocurrency wallet storing cryptocurrency assets held by the cryptocurrency transaction system and acquired by the cryptocurrency transaction system through interfacing with a cryptocurrency source system, wherein the cryptocurrency assets correspond to one or more distinct cryptocurrency addresses associated with a blockchain;
a cryptocurrency ledger storing a plurality of amounts of cryptocurrency owned by the cryptocurrency transaction system, wherein a sum of the plurality of amounts of cryptocurrency owned by the cryptocurrency transaction system equals a total amount of cryptocurrency assets stored in the cryptocurrency wallet; and
a processing device for executing instructions stored in a computer-readable medium, and based on the cryptocurrency transaction system receiving a purchase request from a user of the cryptocurrency transaction system to purchase a good or service from a third-party retailer, the instructions being executable to:
convert the cryptocurrency transaction requested by a client device to a fiat currency transaction associated with a third-party retailer; and
update, via the cryptocurrency ledger, the amounts of cryptocurrency owned by the cryptocurrency transaction system based on a value of the cryptocurrency associated with the purchase request.

20. The system of claim 19, wherein the third-party retailer does not accept cryptocurrency as a form of payment.
